(19) United States
(12) Patent Application Publication
(10) Pub. No.: US 2004/0004739 A1
(43) Pub. Date: Jan. 8, 2004

(54) Printer system, printer, printer control method

(76) Inventors: Toshiaki Koike, Shiojiri-shi (JP); Atsushi Takagi, Shiojiri-shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/452,998

(22) Filed: Jun. 3, 2003

(30) Foreign Application Priority Data
Jun. 5, 2002 (JP) 2002-164911

(51) Int. Cl. G06F 3/12; G06F 15/00; G06F 13/00

(52) U.S. Cl. 358/1.16; 358/1.15

(57) ABSTRACT

[Problem] To provide a printer system, printer, and printer control method capable of quickly running a printing process after print data is received from a host device.

[Means of resolution] Combined print data 50 integrating control data and print data is generated by the print data generator 13 of a host device 11 and sent to the receiving unit 21 of the printer 20. The controller 23 of the printer 20 controls the data transfer unit 24, and transfers combined print data received from the host device directly to the print buffer 25. The controller 23 controls the printing mechanism 26 to print based on the combined print data 50 stored to print buffer 25.

### DETAILED DESCRIPTION OF THE INVENTION

1. Technical Field of the Invention

The present invention relates to a printer system, a printer, and a printer control method capable of high speed printing of print data sent from a host device.

2. Prior Art

Specific content is printed in a conventional printer system, such as a POS system, by sending print data from a host device to a POS printer after sending line control, printing position, density, and other print control commands. After receiving control commands from the host device, the POS printer interprets and internally stores the received control commands together with specified printing conditions. Control data is then generated, and the control data and print data are linked and stored in a print buffer for printing. Technology whereby an image processing device produces PDL data for transfer to an output device is also known as a way to limit the production of data in an intermediate format by the printer (see patent citation 1).

[Patent Citation 1]

Japanese Patent Laid-Open Publication 1999-203061

[Problem to be Solved by the Invention]

However, a fair amount of time is required to interpret control commands, generate control data, and configure the system. The next data that is received cannot be processed until processing the previously received data is completed, and processing received data stored to the reception buffer must sometimes wait. If the received print data cannot be written to the print buffer, printing cannot start and, as a result, there is a drop in the overall printing speed.

There have recently been significant improvements in the data processing capabilities of the host device and data communication speed. This means that even though there is excess capacity for transferring print data from the host device to the printer, the print buffer becomes full because of the time required to interpret the print data and configure the printing conditions on the printer side, and transferring data from the host device to the printer may stop.

Furthermore, the above-noted Japanese Patent Laid-Open Publication 1999-203061 describing a prior art technology for sending PDL data from an image processing apparatus does not clearly teach how PDL data is transferred and processed for printing by the printer. In particular, the technical content of how normal print data and PDL data are discriminated and handled is not described.

The present invention was directed to these problems, and an object of the invention is to provide a printer system, a printer, and a printer control method capable of quickly executing a printing process after receiving print data from a host device.

A further object of the invention is to provide a printer and printer control method for determining an appropriate data transfer method for received print data and executing the appropriate transfer process according to the type of print data.

[Means for Solving the Problem]

Combined print data integrating the printer control data and print data is generated by the host device and sent to the printer in the present invention. The printer transfers the received combined print data directly (DMA transfer) to the print buffer by, for example, direct memory access (DMA). Processes for interpreting the print control commands and generating control data, and writing the control data with the print data to the print buffer, are therefore no longer necessary, and printing can start quickly after receiving the combined print data, thereby solving the above-noted problem.

A printer system according to a first aspect of the present invention is characterized by having: a host device comprising a print data generator for generating combined print data integrating print data and printer control data needed to control a printing process of the printer; and a printer comprising a control unit for controlling internal operation and communication, a reception unit for receiving data including the combined print data sent from the host device, a data transfer unit for directly transferring the received combined print data from the reception unit to a print buffer as controlled by the control unit; and a print processing unit for printing based on the combined print data input to the print buffer.

Because the host device generates and sends print data and control data in a format that can be printed by the printer, the load on the printer caused by processing control commands can be reduced. Furthermore, because the printer transfers and stores both the control data and print data substantially directly to the print buffer, data received from the host device can be quickly processed.

In a printer system according to another aspect of the present invention the printer also has a data interpreting unit for interpreting received data sent from the host device. When the data interpreting unit detects that the following received data is combined print data, the control unit controls the data transfer unit to transfer the following combined print data from the reception unit directly to the print buffer. With this aspect of the invention commands, such as a paper cutting command, other than the combined print data can be sent from the host device and executed on the printer. To minimize the time consumed by command interpreting, for example, the types of commands are preferably limited as much as possible.

A printer according to another aspect of the present invention is characterized by having a control unit for controlling internal operation and communication, a reception unit for receiving data including print data sent from a host device, a data transfer unit for directly transferring part or all of the received data from the reception unit to a print buffer as controlled by the control unit, and a print processing unit for printing based on the received data transferred and stored to the print buffer.

In another embodiment of the invention this printer additionally has a data interpreting unit for interpreting received data. When the following received data is determined by the data interpreting unit to be combined print data integrating print data and printer control data needed to control the printing operation of the printer, the control device controls the data transfer unit to directly transfer the following combined print data to the print buffer.

In another embodiment of the invention this printer also has a selection unit for switching between a normal printing process based on print control commands and print data, and a printing process based on the combined print data. The controller controls each part to execute a normal printing process when the normal printing process is set by the selection unit, and when the printing process using combined print data is set controls directly transferring the combined print data from the reception unit to the print buffer and running the printing process.

The transfer control device of a printer according to a preferred aspect of the invention is characterized by having an interrupt signal generator for generating interrupt signals based on transfer codes received from a host device, an interrupt processor for applying a specific configuration process for handling the data received next by normal data transfer or DMA transfer by means of the interrupt process based on the interrupt signal, and a transfer control unit comprising a DMA transfer unit for directly transferring the following data to a print buffer and a normal transfer unit for transferring the following data to a reception buffer, and transferring the following data by normal transfer or DMA transfer based on the setting of the interrupt processor. With this configuration the transfer method applied to the following data is determined based on a transfer code that is generated according to the type of print data. A transfer process appropriate to the type of print data can therefore be applied without presetting the transfer mode.

The transfer control device of a printer according to another aspect of the invention is characterized by the interrupt signal generator temporarily prohibiting receiving the following data after the transfer code is received; and permitting receiving the following data after the interrupt processor runs a specific configuration process. Because the following data is thus not received until the transfer code type is determined, the following data can be transferred dependably and appropriately.

The transfer control device of a printer according to another aspect of the invention is characterized by the transfer code containing data specifying an interrupt code and the size of the following data. This configuration enables the size of the print data to be freely determined.

The interrupt signal generator of the transfer control device in a printer according to another aspect of the invention is characterized by reading and setting the data size of the following data as the transfer data size of the transfer control unit.

A printer control method according to another aspect of the invention is characterized by having (1) on a host device a step for generating and sending to a printer combined print data integrating printer control data and print data based on a print request from a higher level software application; and having (2) on the printer (a) a step for interpreting received data received from the host device, and sending the following received data directly to a print buffer when the received data is the combined print data, and (b) a step for running a printing process on the printer based on the combined print data stored to the print buffer.

In another embodiment of this printer control method step (1) in the host device comprises a step for setting whether to generate combined print data or data for a normal printing process, and a step for generating data for a normal printing process or combined print data based on this setting; and step (2) (a) in the printer comprises a step for interpreting the received data when the received data is data for a normal printing process, applying a specific required process, and then storing the print data to the print buffer.

In another embodiment of this printer control method step (2) in the printer comprises a step for changing the operating mode according to whether the printing process based on combined print data or the printing process based on data for a normal printing process is run; and step (1) in the host device comprises a step for setting whether to generate combined print data or data for a normal printing process according to the selected operating mode of the printer, and a step for generating the combined print data or data for a normal printing process based on the setting.

A printer control method according to another aspect of the invention is a printing method for receiving from a host device and printing combined print data integrating printer control data and print data. The printer control method is characterized by comprising (1) a step for interpreting received data received from a host device; (2) a step for directly transferring the following received data to a print buffer when the received data is combined print data; and (3) a step for running a printing process based on the combined print data stored to the print buffer.

A transfer control method for a printer according to a preferred embodiment of the invention is characterized by having (a) a step for generating interrupt signals based on transfer codes received from a host device; (b) a step for running a specific configuration process for setting whether following data is transferred by normal data transfer or DMA transfer process by means of an interrupt process based on the interrupt signal; and (c) a step, having a DMA transfer part for directly transferring the following data to a print buffer and a normal transfer part for transferring the following data to a reception buffer, for transferring the following data by normal data transfer or DMA transfer based on the setting of the interrupt process part.

In another embodiment of the invention this transfer control method for a printer is characterized by step (a) temporarily prohibiting receiving the following data after the transfer code is received, and step (b) enabling receiving the following data after the specific configuration process.

In another embodiment of the invention this transfer control method for a printer is characterized by step (b) reading and setting as the transfer data size used in step (c) data specifying the data size of following data contained in the transfer code.

A further aspect of the present invention is a program for executing on a computer the steps of a printing method as described above. The computer has a CPU, logic circuits, memory, and control programs, and executes the steps of the above data communication method by reading this program.

A yet further aspect of this invention is a computer-readable recording medium for storing a program for executing on a computer the steps of a printing method as described above. The computer has a CPU, logic circuits, memory, and control programs, and executes the steps of the above data communication method by reading this program recorded to this recording medium.

[Embodiment of the Invention]

Preferred embodiments of the present invention are described below with reference to the accompanying figures. FIG. 1 is a function block diagram describing the concept of a printer system 10 according to a first embodiment of the present invention. In the present invention the host device 11 generates combined print data in the format input to the print buffer of the printer 20. To simply and clearly describe the invention, only the application program 12 and print data generator 13 are shown as the host device 11 in FIG. 1. The print data generator 13 can, for example, be incorporated into the printer driver (not shown in the figure), and based on print data and other printing information provided from the application program 12 generates combined print data 50 that can be stored directly to the print buffer 25 of the printer 20 and printed. The combined print data 50 is a single data sequence combining the control data and print data sent by control commands, for example, in the prior art as print data 52 containing control data 51 and print images.

When print commands and print data are transferred from the application program 12 to the printer driver (not shown in the figure), the combined print data 50 is generated by the print data generator 13 as controlled by the printer driver. The resulting combined print data 50 is sent from the host device 11 to the printer 20. When the combined print data is received, the controller 23 of the printer 20 controls the data transfer unit 24 to transfer and store the received combined print data 50 directly from the receiving unit 21 to the print buffer 25.

The control data 51 of the combined print data 50 stored to print buffer 25 is read by the firmware, for example, (not shown in the figure) of the controller 23. Under the control of the controller 23, the print data 52 is printed by the printing mechanism 26 based on printing conditions specified by the control data 51.

When data other than combined print data 50 is received from the host device 11 the data received by the receiving unit 21 is temporarily stored to the reception buffer 22, and the content of the received data is interpreted by data interpreter 27. The result is output by the data interpreter 27 to controller 23, and the controller 23 executes a process according to this result. If a cut paper command is received, for example, the cutter (not shown in the figure) is driven according to the received command.

In one possible alternative configuration the combined print data header and length are sent first from the host device 11 so that the printer 20 can check the available print buffer 25 capacity and begin receiving the combined print data following the header and length information only if all combined print data can be received.

In another possible configuration the data interpreter 27 or controller 23 determines if the received data contains commands and print data as in the prior art, or is combined print data as used herein, and runs a conventional printing process or a printing process based on combined print data according to the type of data that is received.

A mode selection unit 28 could alternatively be disposed to the printer 20 as indicated by the dotted line in FIG. 1. Whether a printing process using combined print data or a conventional printing process for printing based on control commands and print data as in the prior art is run is switched by the mode selection unit 28. This switching operation could be achieved using a hardware switch or a control command from the host device. By presetting this selection so that the printer is configured to match the host device 11, the printing process is faster than interpreting and evaluating the data type each time data is received.

Print data according to the prior art and combined print data according to the present invention are described next with reference to FIG. 2. FIG. 2(a) shows by way of example on the left the transfer data, that is, the print control commands and print data, sent from a host device 11 according to the prior art, and shows the image actually printed to the printing paper 60 on the right as an example of the print data image and the cutting position of the printing paper 60. FIG. 2(b) shows data used for the printing process of the present invention by way of example. The transfer data (combined print data and paper cutting command) sent from the host device is shown on the left, and a conceptual image of the combined print data 50 sent from the receiving unit 21 to the print buffer 25 is shown on the right.

With a printing process according to the prior art control commands and print data listed as (1) to (7) on the left side in FIG. 2(a) are sent from the host device to the printer. Printing position command (1) specifies the size of the left margin, for example, to specify the printing position, and density command (2) sets the print density. Print speed command (3) specifies the printing speed according to the printing performance of the printer, and line feed distance command (4) sets the distance between lines. Graphic image (5) is an image of what is to be printed (including text), and includes color data when printing in color. Print command (6) is for starting execution of the printing process after transmitting this control information and print data (1) to (5) ends, and triggers starting actual printing. Cut command (7) is for cutting the printing paper when using a continuous form such as roll paper, and is used by POS printers, for example.

As described above, the prior art method sends print data after sending print control commands and printing parameters from the host device to the printer. A fair amount of time is required to interpret these control commands and run a process according to the control commands. The conventional printing method thus waits until interpreting these control commands and running the specified processes ends before it writes the received print data as a print image to the print buffer. However, if the print data is image data, for example, significant time is required for the process that converts data in the receive buffer to the actual print data and writes the print data to the print buffer because of the large size of the received data.

By contrast, only the combined print data 50 and cut command (7) are sent from the host device 11 with the present invention, and the combined print data is transferred directly from the receiving unit 21 to the print buffer 25. There is, therefore, no waiting for internal processing of the received data by the printer and the print image is written directly to the print buffer. The load on the printer is therefore greatly reduced, and printing can be processed quickly. Furthermore, because the received data is transferred immediately to the print buffer, high speed data communication between the host device 11 and printer 20 can be achieved.

The combined print data 50 combines the control data 51 and print data 52. For example, the size of the image data in the X-Y direction and the offset of the printing position from the left, the print density and printing speed, the number of head energizing periods, and other printing control information, as well as other control information, is stored as the control data 51. It should be noted that this control information is described by way of example only and other printing attributes and control data elements can obviously also be included. The control data 51 is read by controller 23, and is used for controlling the printing mechanism 26 and other parts. The print data is output to and printed by the printing mechanism 26 under the control of the controller 23. It should also be noted that an image of a rabbit is shown by way of example as the print data in FIG. 2, but the print data could include various other images and data.

The operating procedure of a printer system according to the present invention is described with reference to FIG. 3. FIG. 3 is a flow chart showing the printing process run by the host device and the process executed in a printer according to the present invention. When the printer driver of the host device receives printing information and print data based on print commands from the application program, the print data generator produces the combined print data (S101). Once the combined print data is compiled it is sent from the host device to the printer (S102). Data communication can be handled using, for example, a serial transfer protocol such as USB or other serial or parallel transmission method known to one with ordinary skill in the related art. Data communication continues until transmission of all of the combined print data is completed (S103, no). When transmission is completed (S103, yes), processing on the host device side ends (not including status data processing and error handling).

When combined print data is received (S201), the printer sequentially transfers (DMA transfer) the received combined print data by direct memory access (DMA) from the receiving unit to the print buffer (S202). Once all received data is transferred to the print buffer (S203, yes), the control data in the combined print data is read from the print buffer by the controller, and the printing process, including printer drive control, is run based on the control data (S204). This printing process repeats under the control of the controller until printing all print data stored in the print buffer ends (S205, no). When all printing ends (S205, yes), a specific status report is sent to the host device (not shown in the figure) and processing on the printer side ends.

FIG. 4 shows the transfer data stream 55 sent from a host device according to another embodiment of the present invention. This transfer data stream 55 comprises a transfer code 56 specifying the data transfer method inside the printer, and a print data stream 57 following the transfer code 56. The transfer code 56 comprises, for example, a 2-byte interrupt code 58 and a 4-byte transfer data size 59. The transfer code 56 could be configured with only a 2-byte interrupt code 58, i.e., not including the transfer data size 59 information. If the transfer code 56 contains only the interrupt code 58, the transfer size is preferably declared for each interrupt process specified by the interrupt code.

FIG. 5 is a function block diagram showing a preferred embodiment of a printer that receives and prints the data stream shown in FIG. 4. The transfer data stream 55 shown in FIG. 4 is sent from the host device 31 to the printer 40. The printer driver 32 of the host device. 31 generates and sends to the printer 40 a specific transfer code 56 and print data 57 according to the specific request, such as image printing, text printing, paper transportation, and paper cutting, from the application 22.

The transfer data stream 55 from the host device 31 is sent through interface 41 to interrupt signal generator 42. When the interrupt signal generator 42 receives transfer code 56, it generates an interrupt signal from the interrupt code 58 in the transfer code 56, and temporarily prohibits receiving the following print data stream 57 by setting the interface 41 to a busy state, for example. The interrupt signal is output to the interrupt processor 43, which runs an interrupt process based on the interrupt signal. The interrupt process configures the printer according to the interrupt signal to transfer the following print data stream 57 by either a normal data transfer or DMA transfer. The transfer data size 59 in the transfer code 56 is also read and set to the transfer control unit 44 by the interrupt process.

When the interrupt processor 43 ends the specified interrupt process, it enables receiving the following print data stream 57 by setting the interface to a ready state, for example.

The print data stream 57 is then transferred by the transfer control unit 44 by normal data transfer or DMA transfer. If by normal data transfer, the data is passed from the normal transfer unit 45 to the reception buffer 22, and a conventional printing process is run. That is, the print data 57 transferred to the reception buffer 22 is written as a print image (bitmap data) to the print buffer 25 by a conventional printing process as already described above, and data is printed from the print buffer. If the data is transferred by DMA, the combined print data 50 is sent by DMA transfer unit 46 directly to the print buffer 25. When all data processing (transfer) is completed, the next transfer data stream 55 (transfer code 56) can be received.

As will be clear from the above description, the transfer method is automatically determined based on the transfer code, and either a conventional data transfer or DMA transfer is executed, by the embodiment shown in FIG. 4 and FIG. 5. It is therefore not necessary to set the transfer mode in advance using a command, for example, and changing the application 22 to enable direct transfer (DMA transfer) is not necessary. More specifically, the appropriate data transfer method is determined for the received print data, and a transfer process appropriate to the type of print data can be run by a printer according to this embodiment of the invention.

Processing the transfer data stream 55 shown in FIG. 4 is described next using FIG. 6.

When the transfer code 56 of the transfer data stream 55 is received from the host device 31 (S301), the interrupt signal generator 42 sets the interface 41 to a busy state and temporarily prohibits receiving the following data (S302). An interrupt signal is then generated based on the interrupt code 58 in the transfer code 56 (S303), and an interrupt process is run according to the interrupt signal interrupt signal (S304). A specific hardware or software setting enabling a normal data transfer or DMA transfer is set according to the interrupt code in the interrupt process. When the interrupt process ends (S305, yes), the following data (print data stream 57) is sequentially transferred to the reception buffer or print buffer. Print data 57 passed directly to the print buffer is the combined print data described above, and the image in the print buffer can be printed as is.

[Effect of the Invention]

With the present invention as described above combined print data integrating control data and print data is generated in the host device and sent to the printer. The printer can therefore transfer the received combined print data directly to the print buffer by, for example, direct memory access. Processes for first interpreting print commands and then converting and writing the print data to the print buffer are therefore unnecessary. The combined print data can therefore be transferred to the print buffer quickly after being received without transfer of the received data waiting for the print control commands and other received data to be interpreted. Furthermore, because it is not necessary to convert the received print data to the specific printing format stored to the print buffer, the load on the printer is accordingly reduced and the print speed can be improved. Furthermore, by enabling both normal printing and printing based on combined print data according to the present invention, the invention can adapt flexibly to the operating environment. By providing a selection means for preselecting normal printing or printing based on combined print data in this case, the printing speed can be further improved because it is not necessary to determine which printing process to apply each time printing is invoked. Furthermore, by switching the transfer mode based on the transfer code sent from the host device, a transfer mode appropriate to the type of print data can be automatically selected and applied.

### BRIEF DESCRIPTION OF THE DRAWINGS

FIG. 1 is a function block diagram for describing the concept of a printer system and printer according to a preferred embodiment of the invention.

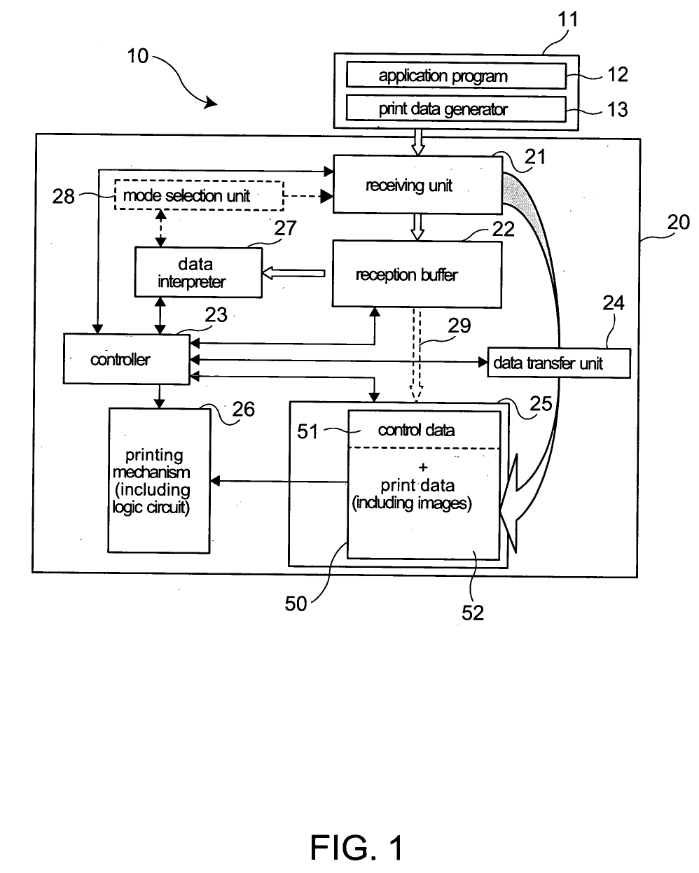

FIG. 2(a) shows a sample print image according to the prior art, and (b) shows a conceptual image of combined print data according to the present invention.

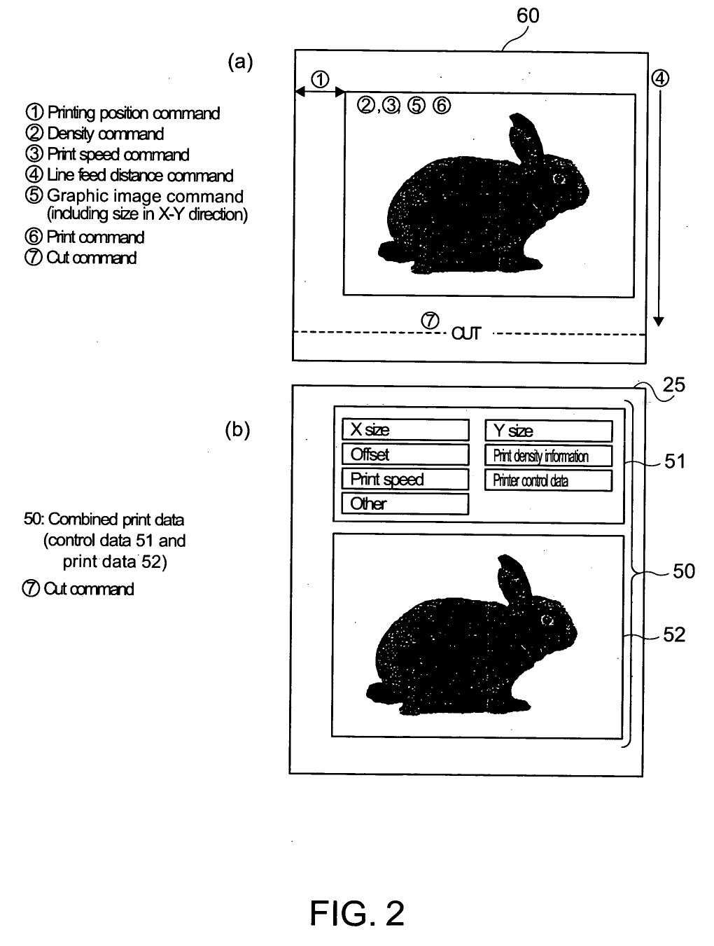

FIG. 3 is a flow chart showing the printing process of a host device and the process run by a printer in a preferred embodiment of the invention.

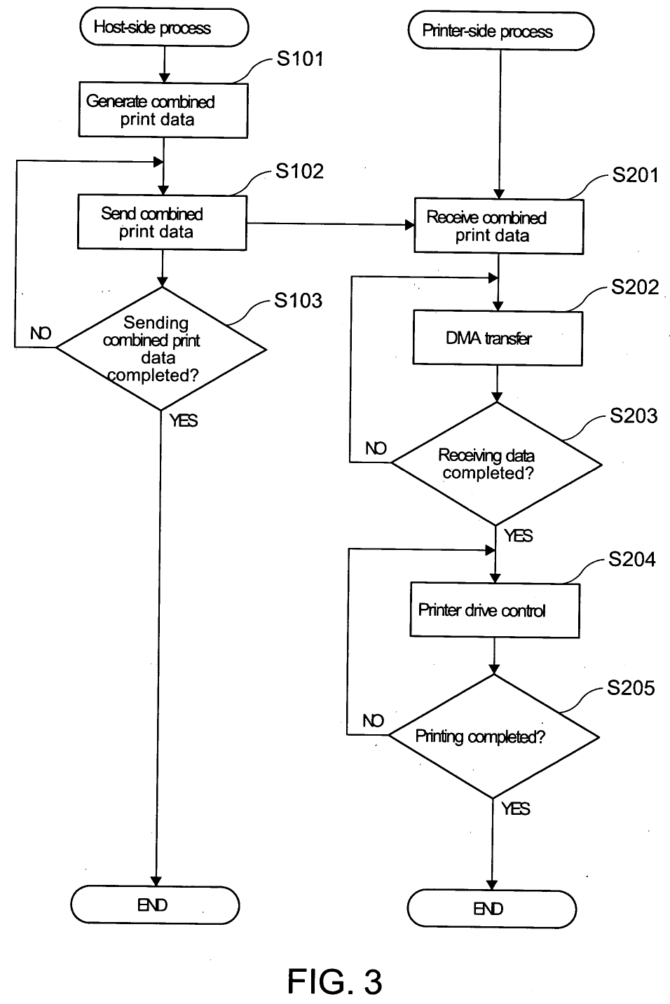

FIG. 4 shows the format of transfer data sent from a host device in another embodiment of the present invention.

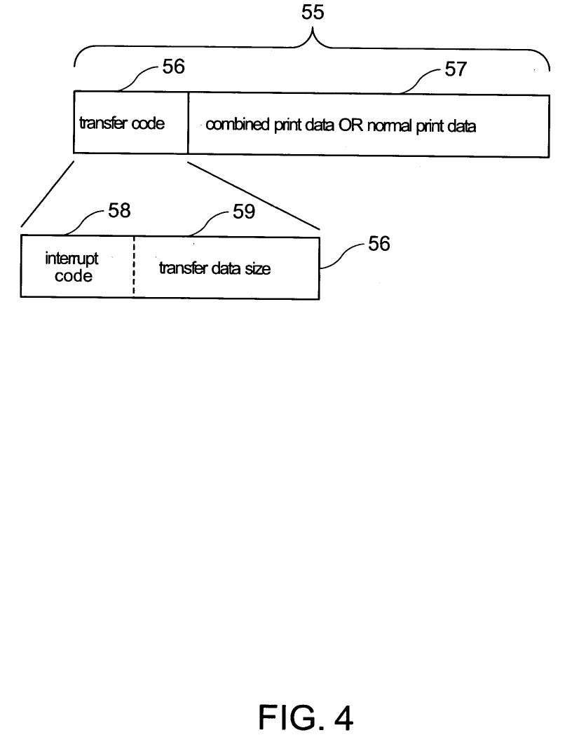

FIG. 5 is a function block diagram showing a preferred embodiment of a printer for receiving and printing the data stream shown in FIG. 4.

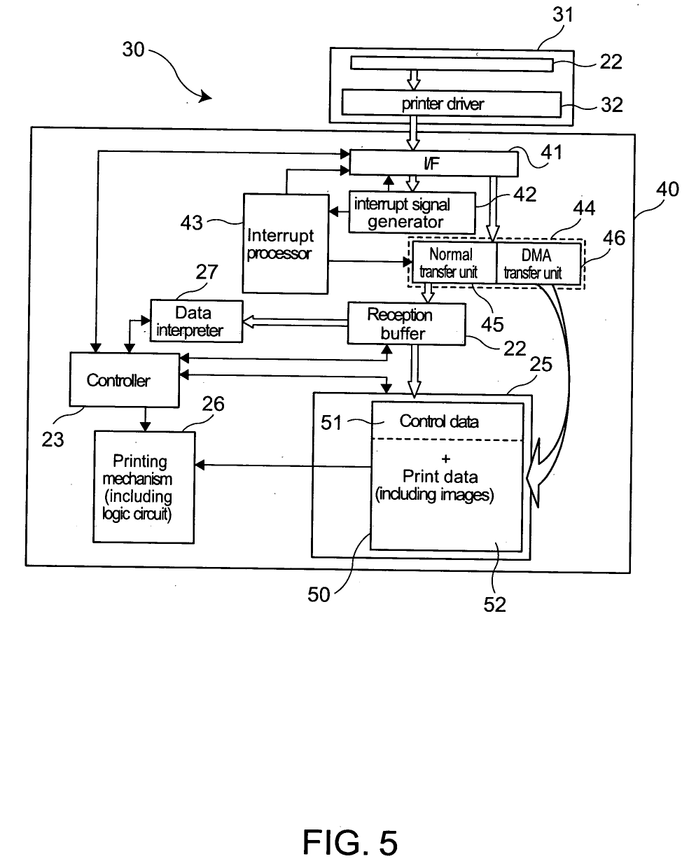

FIG. 6 is a flow chart showing a preferred procedure for processing the transfer data stream shown in the figure.

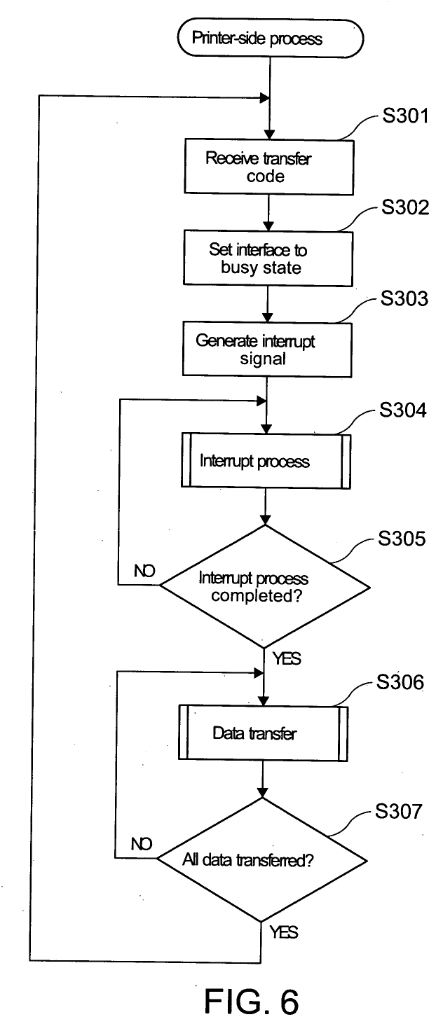

### KEY TO THE FIGURES

printer system 10

host device 11

application program 12

print data generator 13

printer 20

receiving unit 21

reception buffer 22

controller 23

data transfer unit 24

print buffer 25

printing mechanism 26

data interpreter 27 mode

selection unit 28

printer system according to another embodiment 30

host device according to another embodiment 31

printer driver 32

printer according to another embodiment 40

interface 41

interrupt signal generator 42

interrupt processor 43

transfer control unit 44

normal transfer unit 45

DMA transfer unit 46

combined print data 50

control data 51

print data 52

transfer data stream 55

transfer code 56

print data stream 57

interrupt code 58

transfer data size 59

printing paper 60

What is claimed:

1. A printer system characterized by comprising:
a host device comprising a print data generator for generating combined print data integrating print data and printer control data needed to control a printing process of a printer; and
a printer comprising a control unit for controlling internal operation and communication,
a reception unit for receiving data including the combined print data sent from the host device;
a data transfer unit for directly transferring received combined print data from the reception unit to a print buffer as controlled by the control unit; and
a print processing unit for printing based on the combined print data input to the print buffer.

2. A printer system as described in claim 1, the printer further comprising a data interpreting unit for interpreting received data sent from the host device, wherein:
when the data interpreting unit detects that the following received data is combined print data, the control unit controls the data transfer unit to transfer the following combined print data from the reception unit directly to the print buffer.

3. A printer comprising a control unit for controlling internal operation and communication;
a reception unit for receiving data including print data sent from a host device;
a data transfer unit for directly transferring part or all of the received data from the reception unit to a print buffer as controlled by the control unit; and
a print processing unit for printing based on the received data transferred and stored to the print buffer.

4. A printer as described in claim 3 further comprising a data interpreting unit for interpreting received data, wherein
when following received data is interpreted by the data interpreting unit to be combined print data integrating print data and printer control data needed to control a printing operation of the printer, the control device controls the data transfer unit to directly transfer the following combined print data to the print buffer.

5. A printer as described in claim 3 further comprising a selection unit for switching between a normal printing process based on print control commands and print data, and a printing process based on the combined print data, wherein
the controller controls each part to execute a normal printing process when the normal printing process is set by the selection unit, and when the printing process using combined print data is set controls directly transferring the combined print data from the reception unit to the print buffer and running the printing process.

6. A printer comprising an interrupt signal generator for generating interrupt signals based on transfer codes received from a host device;
an interrupt processor for applying a specific configuration process for handling the data received next by normal data transfer or DMA transfer by means of the interrupt process based on the interrupt signal; and
a transfer control unit comprising a DMA transfer unit for directly transferring the following data to a print buffer and a normal transfer unit for transferring the following data to a reception buffer, and transferring the following data by normal transfer or DMA transfer based on the setting of the interrupt processor.

7. A printer as described in claim 6, wherein the interrupt signal generator temporarily prohibiting receiving the following data after the transfer code is received, and permitting receiving the following data after the interrupt processor runs a specific configuration process.

8. A printer as described in claim 6, wherein the transfer code contains data specifying an interrupt code and the size of the following data.

9. A printer as described in claim 8, wherein the interrupt signal generator reads and sets the data size of the following data as the transfer data size of the transfer control unit.

10. A printer control method characterized by comprising:
(1) on a host device a step for generating and sending to a printer combined print data integrating printer control data and print data based on a print request from a higher software level; and
(2) on the printer
(a) a step for interpreting received data received from the host device, and sending the following received data directly to a print buffer when the received data is the combined print data, and
(b) a step for running a printing process on the printer based on the combined print data stored to the print buffer.

11. A printer control method as described in claim printer system 10, wherein step (1) in the host device comprises a step for setting whether to generate combined print data or data for a normal printing process, and a step for generating data for a normal printing process or combined print data based on this setting; and
step (2) (a) in the printer comprises a step for interpreting the received data when the received data is data for a normal printing process, applying a specific required process, and then storing the print data to the print buffer.

12. A printer control method as described in claim host device 11, wherein step (2) in the printer comprises a step for changing the operating mode according to whether the printing process based on combined print data or the printing process based on data for a normal printing process is run; and
step (1) in the host device comprises a step for setting whether to generate combined print data or data for a normal printing process according to the operating mode selection of the printer, and a step for generating the combined print data or data for a normal printing process based on the setting.

13. A printer control method for receiving from a host device and printing combined print data integrating printer control data and print data, characterized by comprising:
(1) a step for interpreting received data received from a host device;
(2) a step for directly transferring the following received data to a print buffer when the received data is combined print data; and
(3) a step for running a printing process based on the combined print data stored to the print buffer.

14. A control method for a printer, characterized by comprising:
(a) a step for generating interrupt signals based on transfer codes received from a host device;
(b) a step for running a specific configuration process for setting whether following data is transferred by normal data transfer or DMA transfer process by means of an interrupt process based on the interrupt signal; and
(c) a step, having a DMA transfer part for directly transferring the following data to a print buffer and a normal transfer part for transferring the following data to a reception buffer, for transferring the following data by normal data transfer or DMA transfer based on the setting of the interrupt process part.

15. A control method for a printer as described in claim 14, wherein step (a) temporarily prohibits receiving the following data after the transfer code is received, and
step (b) enables receiving the following data after the specific configuration process.

16. A control method for a printer as described in claim 14, wherein step (b) reads and sets as the transfer data size used in step (c) data specifying the data size of following data contained in the transfer code.

17. A program for executing on a computer the steps of the method described in claim 10.
